(19) United States
(12) Patent Application Publication
(10) Pub. No.: US 2013/0052324 A1
(43) Pub. Date: Feb. 28, 2013

(54) Low Fat Whippable Emulsions With Dietary Fibers

(71) Applicants: Shri K. Sharma, Amherst, NY (US); Abelardo Gutierrez del Toro, Buffalo, NY (US); Aman K. Sharma, Amherst, NY (US)

(72) Inventors: Shri K. Sharma, Amherst, NY (US); Abelardo Gutierrez del Toro, Buffalo, NY (US); Aman K. Sharma, Amherst, NY (US)

(21) Appl. No.: 13/501,013

(22) PCT Filed: Oct. 11, 2010
(86) PCT No.: PCT/US10/52183

§ 371 Date: Sep. 14, 2012

Related U.S. Application Data
(60) Provisional application No. 61/250,335, filed on Oct. 9, 2009.

(51) Int. Cl. A23G 3/52

(52) U.S. Cl. 426/572; 426/564

(57) ABSTRACT

Provided are methods and compositions for low fat toppings containing fiber and having properties mimicking a higher fat composition. The method comprises preparing the composition such that the fiber is hydrated thereby providing desirable able mouth-feel and organoleptic properties.

### CROSS-REFERENCE TO RELATED APPLICATIONS

This application claims priority to U.S. Provisional application No. 61/250,335, filed on Oct. 9, 2009, the disclosure of which is incorporated herein by reference.

### FIELD OF THE INVENTION

The present invention relates generally to the field of whippable food products and more particularly to a low fat whippable food product containing fiber and having desirable mouth-feel and stability characteristics.

### BACKGROUND OF THE INVENTION

Whippable food products are commonly used as toppings, icings, fillings and the like for cakes and other desserts. Different approaches have been used to obtain formulations that possess desirable characteristics including longer shelf life of both unwhipped and whipped products, ease of preparation and use of the whipped product, stability and performance characteristics; the conditions under which whipping can be performed including the whipping temperature; display temperature and display time; and the ease of spreading of the whipped product etc.

Consumer selection of whippable products also depends upon the feel and taste of the whipped product, and various stability indicators. At the same time, consumers are becoming more conscious about the caloric value of foods. Therefore, low fat preparations are desirable, but reducing fat results in poor organoleptic properties and therefore reduced consumer acceptance.

Accordingly, there is an ongoing and unmet need for whippable products having low fat content but desirable organoleptic characteristics and good stability.

### SUMMARY OF THE INVENTION

The present invention provides topping formulations containing fiber and low fat (10% or less; typically between 1 to 10%) and yet mimicking the mouth-feel and organoleptic properties of compositions containing more than double the fat (such as 20%) fat. The particle size distribution for the compositions of the present invention shows a shift toward larger particle sizes as compared to particle size distributions for the similar formulation without fiber.

The invention also provides a method for preparing a formulation comprising 10% or less fat and 0.1 to 0.5% fiber. The method comprises mixing fiber in the water phase under high shear conditions such that the fiber is substantially or fully hydrated. Other ingredients are then mixed to form topping formulations which are whippable and provide desirable mouth-feel and organoleptic properties. The compositions can be used whipped or unwhipped as toppings or icings on various food products.

### BRIEF DESCRIPTION OF THE DRAWINGS

FIG. 1. Particle size distribution for formulation containing 5% fat and 0.2% fiber (labeled as 208A); and for formulation containing 8% fat and 0.2% fiber (labeled as 208B).

FIG. 2. Particle size distribution for formulation containing 5% fat and 0.2% fiber (labeled as 193B); and for formulation containing 5% fat and no fiber (labeled as 193A).

FIG. 3. Particle size distribution for formulation containing 5% hydrogenated oil without fiber (labeled as “hydrogenated oil without corn fiber”; formulation containing 5% hydrogenated oil with 0.2% fiber (labeled “hydrogenated oil with corn fiber”); and formulation containing 5% non-hydrogenated oil with 0.2% fiber (labeled “non-hydrogenated oil with corn fiber).

FIG. 4. Particle size distribution for formulation containing 20% fat without fiber (labeled as “Regular topping with 20% of Fat”); and for formulation containing 5% fat and 0.2% fiber (labeled as “5% Fat Topping”).

### DETAILED DESCRIPTION OF THE PREFERRED EMBODIMENTS

All percentages are weight percents unless otherwise indicated. When a range is indicated then all percentages or amounts to the tenth decimal point are included within the range.

This invention provides a whippable food product having less than 10% fat and improved stability. The whipped products have good organoleptic characteristics.

The present invention is based on the surprising finding that low fat fiber based topping formulation can be produced if prepared using a particular processing technique. Previously, we had observed that a low fat topping formula developed using corn based fibers was not successful—when the fiber powder was dispersed in the oil with other gums, stabilizers and emulsifiers, it settled at the bottom of the tank and provided no unique functionality. In the present invention, it was surprisingly observed that the fiber needed to be mixed in the aqueous phase using high shear mixing conditions to achieve functionality. It is believed that this was due to the fiber being substantially or fully hydrated. Thus, in one embodiment, the present invention provides a formulation that does not have any detectable sedimented fiber.

In one embodiment, the present formulation comprises water, corn syrup, sugar, hydrogenated palm kernel oil, sodium caseinate, methyl cellulose, sodium stearoyl lactylate, corn dietary fibers, emulsifier, stabilizer and flavor.

Fats

The triglyceride fat component contributes to the stability of the product and is 10% or less. In various embodiments, the fat is 1, 2, 3, 4, 5, 6, 7, 8, 9 and 10%. The fats can be palm kernel oil, coconut oil, or partially hydrogenated, hydrogenated or winterized fraction of the above, or palm oil, cottonseed oil, lard, tallow or a stearin fraction of any of the above. In one embodiment, the triglyceride fat component is the hydrogenated stearin fraction of palm kernel oil. In one embodiment, the only fat present in the composition is palm kernel oil, coconut oil, or a combination of palm kernel oil and coconut oil or any faction thereof.

Fiber

The fiber in the present formulation is insoluble fiber. In one embodiment, the fiber is corn fiber or oat fiber. The corn or oat fiber is a multifunctional food ingredient which functions as a stabilizer with thickening, texturization and water binding agent; also an emulsifier with fat mimicking properties with binding, shaping, suspension and pH control attributes. It is an insoluble dietary fiber with non-caloric value and complements to oil, gums and starches. In the present invention it was observed that it can replace the organoleptic functionality of fats without affecting the taste, mouth feel and texture. In one embodiment, corn or oat fibers can be used at 0.1, 0.2, 0.3, 0.4, or 0.5%. An example of a suitable fiber is the Z-trim fiber.

Emulsifiers

A wide variety of emulsifiers may be employed in amounts on the same order as known in the art of oil-in-water emulsions, for example, about from 0.1% to 0.6%, preferably about from 0.2% to 0.4% as permissible under FDA guidelines. Suitable emulsifiers include lecithin, hydroxylated lecithin; mono, di, or polyglycerides of fatty acids, such as stearin and palmitin mono and diglycerides, polyoxyethylene ethers of fatty esters of polyhydric alcohols, such as the polyoxyethylene ethers of sorbitan monostearate (polysorbate 60) or the polyoxyethylene ethers of sorbitan distearate; fatty esters of polyhydric alcohols such as sorbitan monostearate; polyglycerol esters of mono and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate, and calcium or sodium stearoyl lactylates and all members of the sucrose ester family thereof, all varieties of diacetyltartaric esters of fatty acids, “DATEMS”, and the like, and mixtures thereof.

Stabilizers

The emulsion compositions of the present invention may also include one or more stabilizers of hydrophilic colloids. These stabilizers are natural, i.e. vegetable, or synthetic gums and may be, for example, carrageenan, guar gum, alginate, xanthan gum and the like or methylcellulose (Methocel A 15 & A 400), carboxy-methylcellulose, ethylcellulose, hydroxy-propylmethylcellulose (METHOCEL F-50 HG), and microcrystalline cellulose. Typically, a gum or combination of gums is employed with a sugar, e.g. dextrose, carrier. The amount of these stabilizers can be varied widely in accordance with the amounts required in prior art compositions, generally about from 0-2%, preferably about 0.1-0.5% as permissible under FDA guidelines. In one embodiment, the stabilizers are 0.3 to 1.0% and in another embodiment, the stabilizers are 0.4 to 0.8%.

Proteins

Milk proteins such as isolated sodium, potassium or calcium caseinates, protein provided as skim milk, nonfat dry milk, milk protein concentrate, whey protein concentrates, whey protein isolates, alpha lactalbumin and beta lactoglobulin can be used. The proteins are generally known to assist in the emulsification and stability of the whipped products. Vegetable proteins including but not limited to soy protein, pea protein, wheat protein, cottonseed protein, peanut protein, and corn protein are also useful. Suitable protein concentration is 0.5 to 2.0% and all percentages therebetween to the tenth decimal place.

Sweeteners

The sugars useful for the present invention include, monosaccharides, disaccharides and polysaccharides. The sweeteners may be comprised of one or more sugars, such as sucrose, fructose, dextrose and/or intensive sweeteners, such as aspartame, acetosulfame, alitame, saccharin, cyclamates, and trichloro sucrose. Suitable sugars concentrations are 10-20% and all percentages therebetween. In the event one or more intensive sweeteners are used, bulking agents may be included in the formulation to provide additional solids and provide body to the foam structure. Typical bulking agents would be maltodextrin, polydextrose, polyglucose, xylitol, mannitol and sorbitol. For formulation calculations, all of these materials are considered to be included in the sweetener component. For taste purposes and for ease of operation, the sweetener component will normally consist of sucrose or sucrose-fructose combinations. The formulation may also contain high fructose corn syrup, corn syrups with varying levels of dextrose equivalents such as 36DE, 43DE, 63DE or powder of corn syrup solids. Corn syrup solids are in the range of 10-25% and all percentages therebetween.

Salts

The salts useful for the present invention is any edible salt that does not interfere with other ingredients or render an undesirable taste. Salts generally act as buffers. Examples of useful salts are common salt (sodium chloride), sodium or potassium phosphates, citrates, chlorides, and the like. Salts are generally used in the range of 0.1 to 0.5%.

Other Ingredients

Other ingredients that are useful for the present invention include flavoring agents, colorants, vitamins etc. Suitable flavoring agents can be employed to impart vanilla, cream, chocolate, coffee, maple, spice, mint, butter, caramel, fruit and other flavors.

The following table provides examples of low fat toppings. In various embodiments, the compositions of the present invention comprise, consist essentially of, or consist of the formulations provided in Tables 1 and 2 and other formulations provided herein].

TABLE 1

| | Range for | Preferred |
|---|---|---|
| | Ingredients | Range |
| Ingredients % | (wt %) | (wt %) |
| Water | 35-65 | 40-60 |
| Fat | 4-10 | 5-8 |
| Protein | 0.5-2.0 | 0.6-1.0 |
| Emulsifier | 0.1-0.6 | 0.2-0.4 |
| Sugar | 10-20 | 12-18 |
| Corn syrup solids | 10-25 | 15-20 |
| Gums & Stabilizer | 0.3-1.0 | 0.4-0.8 |
| Salt | 0.1-0.5 | 0.2-0.4 |
| Corn or Oat fibers | 0.1-0.5 | 0.2-0.3 |
| Color | 0.001-0.05 | 0.01-0.03 |
| Flavor | 0.1-0.6 | 0.2-0.4 |

The following table provides two examples of low fat toppings.

TABLE 2

| | Formula 1 | Formula 2 |
|---|---|---|
| Ingredients | Wt % | Wt % |
| Fat | 5.00 | 8.00 |
| SSL | 0.30 | 0.30 |
| Sugar | 16.00 | 16.00 |
| Corn syrup solids | 20.00 | 18.00 |
| (presented as solids, but can | | |
| be either liquid syrup or dry | | |
| powder solids. | | |
| Sodium Caseinate | 0.60 | 0.60 |
| Methocel and/or gums | 0.45 | 0.45 |
| Salt & Buffer salt | 0.22 | 0.22 |
| Z-Trim Fiber | 0.20 | 0.20 |
| Flavor cream | 0.20 | 0.20 |
| Water | 57.03 | 56.03 |
| Total | 100.0 | 100.0 |

The whipped product produced according to the above method can be stored and distributed in a frozen form or at refrigerated temperatures.

To obtain a whipped confection, the whippable product of the present invention can be whipped using a paddle, whip, traditional batch mixers (Hobart, Kitchen Aid, Kenwood etc), aeration devices including continuous mixers and the like. The whippable product can be whipped to an overrun of about 400% or more.

A variety of whipped confections can be made from the product of this invention. Such confections include fillings, icings, toppings, decorations and the like which can be used for cakes, pies, cookies and the like. The toppings, icings and fillings are used according to routine methods. Further, the whipped product of the present invention may be used with other components to provide desired toppings, icings or fillings.

The following example further illustrates the invention, but are not intended to be limiting in any way.

### EXAMPLE 1

Method of Preparation:

Z-trim sample was obtained from the Z-Trim Holding Inc. It is a plant-derived corn dietary fiber with a cellulose-to-hemi-cellulose ratio of approximately 80:20. Z Trim has high viscosity, water holding properties and fat mimic properties. Fat used was fully hydrogenated stearin fractionated palm kernel oil; Corn syrup solids were 63DE/43. The formulas contained no high fructose corn syrup

Some samples were prepared in mini homogenizer system with and without Z-trim dietary fibers with 5% and 8% fat content (193A, 193B, 193C, 193D). 193B is Formula 1 from Table 2; 193D is Formula 2 from Table 2; 193A is Formula 1 without any fiber; and 193C is Formula 2 without any fiber. Additional samples were prepared and were run in the pilot lab to confirm the results.

The key processing step in manufacturing low fat topping is mixing corn or oat dietary fiber under high shear mixing conditions (for example mixing at a setting or 9 or 10 on a hand held Kitchen Aid blender) with other major ingredients such as water, sugar, corn syrup, emulsifier and stabilizer. The corn fiber becomes fully functional upon hydration in water under high shear mixing at 50 to 65° C.; otherwise it settles down at the bottom of the container/tank with no useful or unique characteristics. Upon mixing of corn fiber, protein, emulsifier, stabilizer, sugar and corn syrup, palm kernel or vegetable oils are added to the mix under normal agitation. The mix is heated at 165 to 175° F. and held for 5 to 15 min for pasteurization before homogenization and cooling. The homogenization is done in single stage or double stage at 1500 to 6500 (first stage) 0 to 500 PSI at second stage for a total of 3000 to 7000 psi. The resulting homogenized emulsion is cooled using plate or tubular heat exchanger in single or double stages at 85 to 95F (first stage) and final cooling to 35 to 45° F. in second stage. The cooled product is packaged in suitable containers and frozen at −18° C. for 3 to 10 days. The frozen product is thawed and whipped on Hobart, Kitchen Aid or other manual mixer to suitable texture and firmness for final application on cake decoration or used in fillings. In case of pre-whipped product, the cooled product is held at refrigerated temperature (45 to 50° F.) for 0.5 to 24 hours before being whipped on a continuous type of mixer. It should be understood that when ranges are disclosed in integers, all integers between the ranges are also disclosed, and when a range is disclosed between a value given to the tenth of a decimal and an integer or between two values given to the tenth of a decimal, all values therebetween to the tenth of a decimal are disclosed.

The pre-whipped product exhibited some unique properties after freezing and had texture of ice-cream like products. It can be consumed directly from the freezer as ice-cream or frozen novelty desserts. A summary of the evaluation results for topping with 5% and 8% fat are shown in table in Table 3.

TABLE 3
Summary of evaluation results for 5% and 8% fat containing Topping

| | | | | | | | Sta- |
|---|---|---|---|---|---|---|---|
| | Whip | % | Rosette | | | Stability | bility |
| | Time | Over | time, | | | of | in |
| Products | (min) | run | min | Taste | Texture | Cake | Bowl |
| 1. 934- | 45 | 453- | 80-90 | Good | Soft | Soft, | Air |
| 193A | | 483 | | | | little | cell |
| sample, | | | | | | bulging | coa- |
| 5% | | | | | | and | les- |
| fat, no | | | | | | cracking | cence |
| Z-trim | | | | | | | |
| 2. 934-93B | 30 | 394- | 60-65 | Good | Smooth, | Good | Good |
| sample, 5% | | 430 | | | firm | | |
| fat, with | | | | | | | |
| 0.2% | | | | | | | |
| Z-trim | | | | | | | |
| 3. 934-193C | 90 | 393- | 55-60 | Good | Smooth, | Good | Good |
| sample, 8% | | 421 | | | slightly | | |
| fat, no | | | | | soft | | |
| Z-trim | | | | | | | |
| 4. 934-193D | 25 | 399- | 35-40 | Good, | Smooth, | Good | Good |
| sample, 8% | | 426 | | | firm | | |
| fat, 0.2% | | | | | | | |
| Z-trim | | | | | | | |
| 5. 934-208A | 60 | 437- | >60 | Good | Smooth, | Good | Good |
| sample, | | 480 | | | not very | | |
| 5% fat, | | | | | firm | | |
| with 0.2% | | | | | | | |
| Z-trim | | | | | | | |
| 6. 934-208B | 20 | 422- | 55-60 | Good, | Smooth, | Good | Good |
| sample, 8% | | 440 | | | firm | | |
| fat, 0.2% | | | | | | | |
| Z-trim | | | | | | | |

Note:
208A is the same as 193B and 208B is the same as 193D. An indication of ″Good″
means that whipped product had no air cell coalescence, syneresis (water separation) or
bulging or bubbling on the cake.

Some features of the present toppings are as follows:

The 5% fat sample provides less than 0.5 g fat per 9 g serving size and therefore is desirable for calorie conscious individuals. The sample 193A with no Z-trim was very soft and was not stable on cake and bowl, compared to the sample 193B with 0.2% Z-trim fibers which provided good smooth, firm texture and mouth feel similar to regular fat like topping. It also had good stability on cake with no cracking, bubbling or bulging after 24. Similarly, it showed good stability in bowl with no syneresis, cracking or air cell coalescence. After 48 hours, the sample showed some soft texture with air cell coalescence and syneresis. The results in pilot lab samples (208A) also showed comparable results. The results in the pilot lab confirmed the evaluation results obtained earlier on a bench scale.

The 8% fat sample (samples 193C and 193D) also showed good performance and stability. Sample 193D also had firmer texture compared to sample 193C. The results were reproducible in pilot lab made sample as shown in FIG. 3 for sample 208B.

The Z-trim has right particle size with slippery characteristics, which provided good firm texture, smoothness and full fat like attributes in fat free toppings.

TABLE 4
Particle size (microns)
of 5% fat and 8% fat Topping

| | | D [4, 3] | D [3, 2] | | | | |
|---|---|---|---|---|---|---|---|
| | | Volume | Surface | | | | |
| | | weight- | weight- | | | | |
| | Resid- | ed | ed | | | | |
| Sample | ual | mean | mean | d(0.1) | d(0.1) | d(0.5) | d(0.9) |
| Low Fat | 0.803 | 54.749 | 4.962 | 9.925 | 9.925 | 33.766 | 120.567 |
| Topping | | | | | | | |
| (5% fat) | | | | | | | |
| topping | | | | | | | |
| with corn | | | | | | | |
| fiber 934- | | | | | | | |
| 208A | | | | | | | |
| Low Fat | 0.952 | 37.873 | 0.426 | 0.116 | 0.116 | 22.752 | 93.090 |
| (8%) | | | | | | | |
| topping | | | | | | | |
| with corn | | | | | | | |
| fiber | | | | | | | |
| 934-208B | | | | | | | |

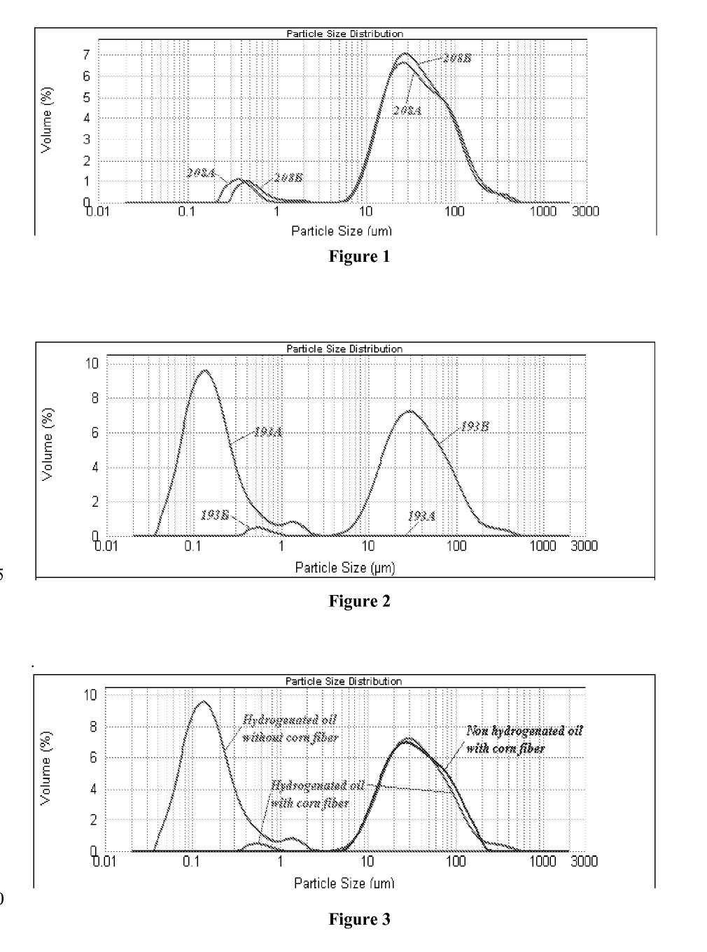

The particle sizes of fat free and low fat toppings are shown in Table 4 and FIG. 1. The 2^{nd} peak in the range of 5 to 200 micron size is represented by Z-trim corn or oat fibers present in the toppings. These particles of corn fibers and oat fibers provide fat like properties in terms of mouth feel, texture and other sensory characteristics. The terms microns and micrometers are used interchangeably.

There is a significant difference in particle size in fat free fat toppings with the presence of corn fiber (193B) or without corn fiber (193A) as shown in Table 5.

TABLE 5
Particle size analysis of low
fat topping with and without corn fiber

| | | D [4, 3] | D [3, 2] | | | |
|---|---|---|---|---|---|---|
| | | Volume | Surface | | | |
| | | weighted | weighted | d | d | d |
| Sample | Residual | mean | mean | (0.1) | (0.5) | (0.9) |
| 934-193A | 0.899 | 0.242 | 0.121 | 0.068 | 0.139 | 0.406 |
| without corn | | | | | | |
| fiber | | | | | | |
| 934-193B | 0.991 | 43.552 | 0.957 | 0.254 | 29.032 | 97.506 |
| with corn fiber | | | | | | |

The volumetric weighted mean particle size diameter of topping without corn fiber is 0.242 micron compared to 43.552 micron for topping with the presence of corn fibers. This can also be seen more clearly in FIG. 2. The topping 934-193A has main first peak in the range of 0.05 to 1 micron, whereas the topping 193B has very small first peak and very large second peak 5 to 200 micron size. It is considered that the second peak of corn fiber is at least in part responsible for mimicking the fat like properties of the overall topping characteristics.

In one embodiment, the 90% of the particles are between 5 and 200 microns (micrometers). In another embodiment, at least 90% of the particles are larger than 2 microns. In another embodiment, at least 90 to 95% particles (and all percentages therebetween) are larger than 2 microns. In yet another embodiment, at least 50, 60, 70, 80, 90 or 95% of the particles are between 1 micron and 200 microns or between 2 and 200 microns. In yet another embodiment, at least 50, 60, 70, 80, 90 or 95% of the particles are between 1 micron and 150 microns. In another embodiment, between 80 to 90% particles are between 5 and 200 microns. It is considered that the size distribution, at least in part responsible for the desirable properties, is due to mixing of fiber in the water phase under high shear conditions leading to hydration of the fiber.

In another embodiment, the volume weighted mean of the particle size of the present invention is at least 30 microns. In various embodiments, it can be 30, 35, 40, 45, 50, 55, and 60 microns (and all values to the tenth decimal place therebetween) or between 30 to 60 microns.

In another embodiment, the samples were prepared with hydrogenated and non-hydrogenated oil with corn fiber and compared to a sample without corn fiber. Results on particle size are shown in FIG. 3 and Table 6.

TABLE 6

| Sample | Particle size distribution |
|---|---|
| Sample with hydrogenated oil and | 98.03% of the particles size is |
| without corn fiber | between 0.047 μm and 2 μm |
| Sample with hydrogenated oil and | 97.81% of the particles size is |
| with corn fiber | between 4.743 μm and 474.275 μm |
| Sample with non hydrogenated oil | 99.37% of the particles size is |
| and with corn fiber | between 6.325 μm and 200 μm |

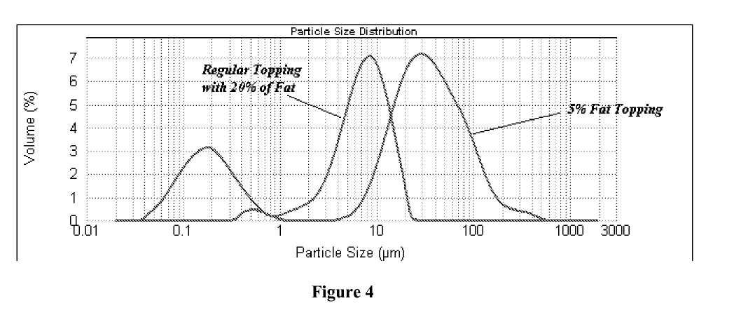

It is considered that at least part of the reason why the formulations of the present invention provide organoleptic properties mimicking higher amount of fat is that the fiber prepared as described herein provides particles sizes closer to the particle size distribution seen with higher fat. For example, as shown in FIG. 4, the particle size distribution of 5% fat containing fiber is significantly different from that of 5% fat without fiber and is closer in particle size distribution to 20% fat. These larger particles are at least in part responsible for providing a good mouthfeel and desirable organoleptic properties.

While the invention has been described through specific embodiments, routine modifications will be apparent to those skilled in the art and are such modifications areintended to be covered within the scope of this invention.

1. A whippable composition comprising 1 to 10% fat, 0.1 to 0.5% fiber, 0.5 to 2.0% protein, 0.1 to 0.6% emulsifiers, 10-20% sweeteners, 0.3 to 1.0% stabilizers and 35 to 65% water.

2. The composition of claim 1 further comprising 10-25% corn syrup solids.

3. The composition of claim 1, wherein 90% of the particles are between 1 and 200 micrometers.

4. The composition of claim 1, wherein the volume weighted mean of the particles is between 30 to 60 microns.

5. The composition of claim 1, wherein the fiber is a combination of oat and corn.

6. The composition of claim 1, wherein the fiber is oat.

7. The composition of claim 1, wherein the fiber is corn.

8. The composition of claim 1, wherein the fat is palm kernel oil or coconut oil or combinations and fractions thereof.

9. The composition of claim 2, wherein the fat is from 5 to 8%, protein is from 0.6 to 1.0%, sweetener is from 12 to 18%, corn syrup solids are from 15 to 20%, and fiber is from 0.2 to 0.3%.

10. A confection comprising a whipped composition prepared from the formulation of claim 1.

11. A whippable composition having from 1 to 10% fat and 0.1 to 0.5% fiber, and having a particle size distribution in which at least 90% of the particles are from 2 to 200 microns, wherein said composition has been prepared under conditions such that the fiber is hydrated.

12. The composition of claim 11, wherein the fat is palm kernel oil and the fiber is oat, corn or a combination thereof.

13. The composition of claim 12, wherein the fiber is from 5 to 8%.
